(19) United States
(12) Patent Application Publication
(10) Pub. No.: US 2026/0162371 A1
(43) Pub. Date: Jun. 11, 2026

(54) Method for Generating a Ball Model of an Object for Generating Realistic Poses

(71) Applicant: Robert Bosch GmbH, Stuttgart (DE)

(72) Inventors: Pascal Herrmann, Burgdorf (DE); Paul Robert Herzog, Hildesheim (DE); Dennis Mack, Sibbesse (DE); Maarten Bieshaar, Fritzlar (DE)

(21) Appl. No.: 19/407,164

(22) Filed: Dec. 3, 2025

(30) Foreign Application Priority Data
Dec. 5, 2024 (DE) 10 2024 211 650.5

(51) Int. Cl. G06T 17/20; G06T 7/73; G06T 19/20

(52) U.S. Cl. CPC G06T 17/20; G06T 7/75; G06T 19/20; G06T 2200/04; G06T 2207/20081; G06T 2207/20084; G06T 2210/21; G06T 2219/2004

(57) ABSTRACT

A method of generating a ball model of an object for generating realistic poses includes receiving a wire mesh model of the object, which has a skeletal structure, generating a first ball model from the wire mesh model, generating a second ball model from the first ball model by determining, for each ball of the first ball model, a number of nearest points of the wire mesh model, and, for each of one or more joints of the skeletal structure, calculating a weight for the balls by averaging the weights of the points nearest to the joint, and assigning the calculated weight to the ball.

The present disclosure relates to a method for generating a ball model of an object for generating realistic poses.

Training machine learning models that process images requires a high number of training images. In order to avoid the effort involved in collecting and annotating real images, training images can be synthesized. In the case of training images showing people, it is desirable to be able to render people efficiently in realistic poses.

According to various embodiments, a method of generating a ball model of an object for generating realistic poses is provided, comprising receiving a wire mesh model of the object, which has a skeletal structure, generating a first ball model from the wire mesh model, generating a second ball model from the first ball model by determining, for each ball of the first ball model, a number of nearest points of the wire mesh model, and, for each of one or more joints of the skeletal structure, calculating a weight for the balls by averaging the weights of the points nearest to the joint, and assigning the calculated weight to the ball.

The method described above enables the generation of a ball model that allows the generation of realistic poses and thus the generation of image data showing humans, animals, or even robots in realistic poses.

The use of a ball model allows three-dimensional geometry to be approximated by a set of simple geometric primitives. In addition, in contrast to triangles, checking whether (self)collision is present is easy and quick for balls. Instead of thousands of triangles, only a few hundred balls are needed to depict the 3D geometry of a virtual person, reducing both the memory required for representation and the number of collision tests. By selecting the number of balls, it is possible to achieve a fine balance between an accurate representation of the virtual person and the number of collision tests to be performed.

The ball model may be utilized to generate virtual people (or animals or robots or other moving objects) in random but realistic poses. These virtual people can then be placed in virtual environments to create synthetic images that contain people in realistic poses. Knowing the pose and position of the virtual person means that the synthetic images have annotations available that can be utilized for training an ML (machine learning) model (in particular an object detector). They can also be used as test, verification, or validation data to verify whether a trained ML model can be operated safely.

The method described above may be used to create images of people in a variety of poses and situations. In particular, poses and situations are conceivable here, which usually do not occur in training data sets (e.g., anomalies). With these images, it can now be checked whether a system to be tested (e.g., containing a trained object detector) reacts robustly to these scenarios.

The method described above may also be used for “human motion capture” (MoCap) by generating and using poses from the ball model. The MoCap captures real person movements. For this purpose, (e.g., black) suits are used on which reflective markers are placed. The goal then is to infer the pose, i.e., the skeletal structure, of the person from these markers. Since the markers are attached to the surface of the person, they can be considered points with zero distance to the person. A human ball model (generated using the above method) may now be utilized to obtain the pose for the given markers: In an optimization method, the pose of a ball model may be altered such that all points (corresponding to the markers) lie on the surface of the ball model. The pose for the given markers is thus obtained via the skeletal structure of the ball model.

Various exemplary embodiments are specified in the following.

Exemplary embodiment 1 is a method of generating a ball model of an object for generating realistic poses, as described above.

Exemplary embodiment 2 is a method according to exemplary embodiment 1, comprising calculating the weight for each joint of the skeletal structure and assigning a predetermined number of weights to the ball that are largest among the calculated weights.

In other words: Each ball is associated with joints, which are the ones for which the highest weights are obtained, i.e., a ball is associated with four joints, for example, wherein these joints are those for which the highest weights were calculated by averaging the weights of the points nearest to the joint.

Thus, the ball model reflects the type of movement given by the skeletal structure of the wire mesh model so that the ball model provides realistic poses, as long as the wire mesh model and its skeletal structure are accurate.

Exemplary embodiment 3 is a method according to exemplary embodiments 1 or 2, comprising generating the first ball model from the wire mesh model by means of a neural network that obtains a randomly selected state vector from a state space as an input, wherein the state vector is adjusted in such a way that the first ball model approximates the wire mesh model (i.e., such that the ball model matches the wire mesh model according to a predetermined matching criterion (e.g., as well as possible)).

Thus, descriptively speaking, the neural network operates as a generative model in the manner of a decoder. In this way, realistic ball models may be generated after training the neural network.

Exemplary embodiment 4 is a method according to one of exemplary embodiments 1 to 3, comprising training the neural network to reduce a loss comprising at least a portion of the following loss components:
a loss component penalizing a deviation of a ball model generated for a training wire mesh model by the neural network from the training wire mesh model;
a loss component penalizing for each ball of a ball model generated for a training wire mesh model by the neural network, if the ball does not overlap with the training wire mesh model; and
a loss component penalizing a deviation of a probability distribution sampled from state space from a predetermined probability distribution.

This allows for effective training of a neural network for generating ball models from wire mesh models.

Exemplary embodiment 5 is a method of generating a pose of an object, comprising generating a ball model of an object according to one of exemplary embodiments 1 to 4, and generating a pose by modifying the midpoint positions of at least a portion of the balls of the ball model, taking into account the weights assigned to the balls.

Exemplary embodiment 6 is a method according to exemplary embodiment 5, comprising checking the generated pose for self-collisions by checking, for pairs of balls in the ball model, whether the balls in the generated pose overlap and, in the case of one or more self-collisions, modifying the pose to avoid at least a portion of the one or more self-collisions.

In this way, a realistic pose can be generated in which no body parts overlap.

Exemplary embodiment 7 is a method according to exemplary embodiment 6, wherein modifying comprises moving apart overlapping balls by moving one or more joints associated with the overlapping balls by means of weights assigned to the balls.

Exemplary embodiment 8 is a method of generating training images for a machine learning model, comprising generating a pose of an object according to of exemplary embodiments 1 to 7 and rendering the object in the pose in front of a background.

This can be done by bringing the wire mesh model into the generated pose and rendering the object (i.e., an image of the object) from the wire mesh model.

For example, the machine learning model is trained using the training images to detect objects (e.g., pedestrians) in an image and/or determine, from one or more images, the distance, speed, and/or acceleration of an object represented by the ball model (e.g., a pedestrian). It (or results provided by it) may also be trained or used to track such an object. Thus, for example, training images may be generated for an object detector and training of the detector can occur using the training images. The object detector may then be used to detect objects in the area surrounding a robotic device and the robotic device may then be controlled based on detected objects (e.g., humans may be avoided). The term “robotic device” can be understood as relating to any technical system (with a mechanical part whose movement is controlled), such as a computer-controlled machine, a vehicle, a household appliance, an electric tool, a manufacturing machine, a personal assistant, or an access control system.

Exemplary embodiment 9 is a method for training a machine learning model for detecting objects, comprising generating training images for a machine learning model according to exemplary embodiment 8, and training the machine learning model using the training images.

Exemplary embodiment 10 is a method for controlling a robotic device, comprising training a machine learning model according to exemplary embodiment 9, detecting one or more objects in the area surrounding the robotic device, and controlling the robotic device on the basis of the one or more detected objects.

Exemplary embodiment 11 is a data processing system which is set up to perform a method according to one of exemplary embodiments 1 to 10.

Exemplary embodiment 12 is a computer program with instructions that, when executed by a processor, cause the processor to carry out a method according to any of exemplary embodiments 1 to 10.

Exemplary embodiment 13 is a computer-readable medium that stores instructions that, when executed by a processor, cause the processor to perform a method according to any of exemplary embodiments 1 to 10.

In the drawings, similar reference signs generally refer to the same parts throughout the different views. The drawings are not necessarily to scale, wherein emphasis is instead generally placed on representing the principles of the invention. In the following description, various aspects are described with reference to the following drawings.

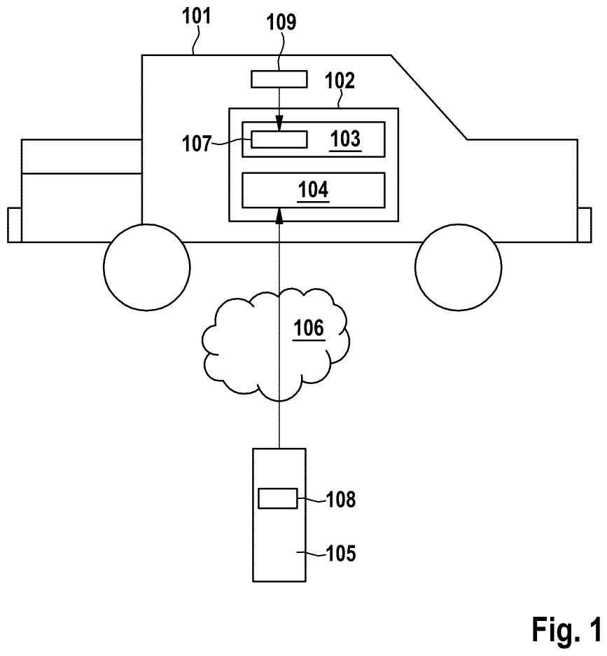

FIG. 1 shows a vehicle.

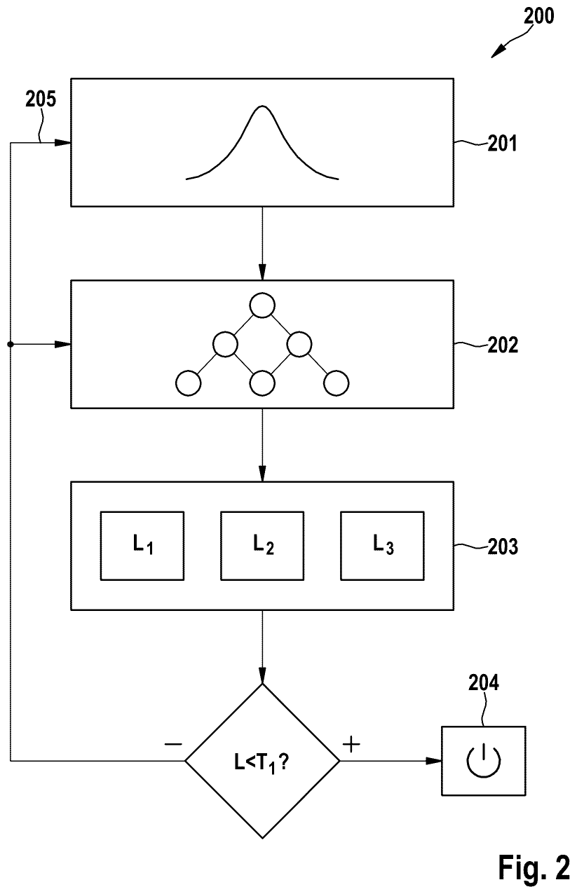

FIG. 2 shows a flow chart illustrating the training of a neural network to convert a wire mesh into a ball model.

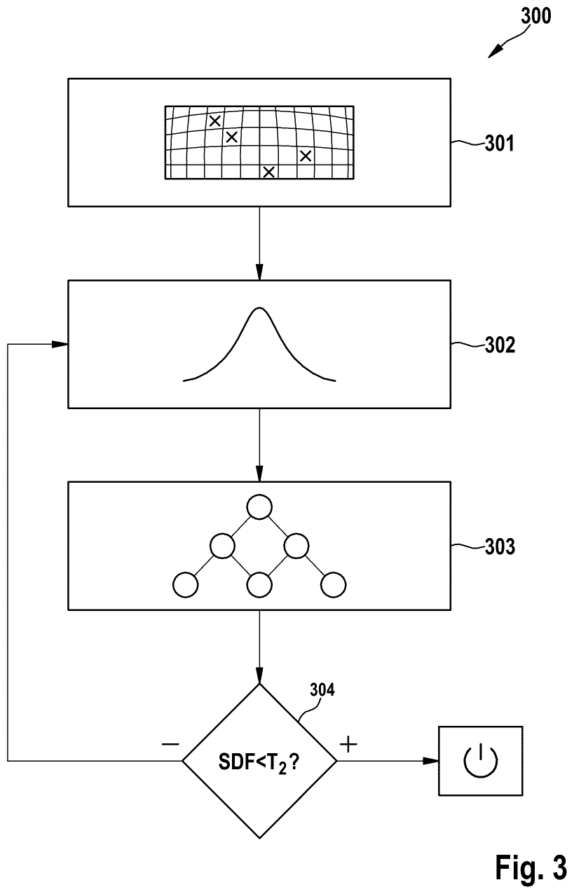

FIG. 3 shows a flow chart illustrating the generation of a ball model for a wire mesh model.

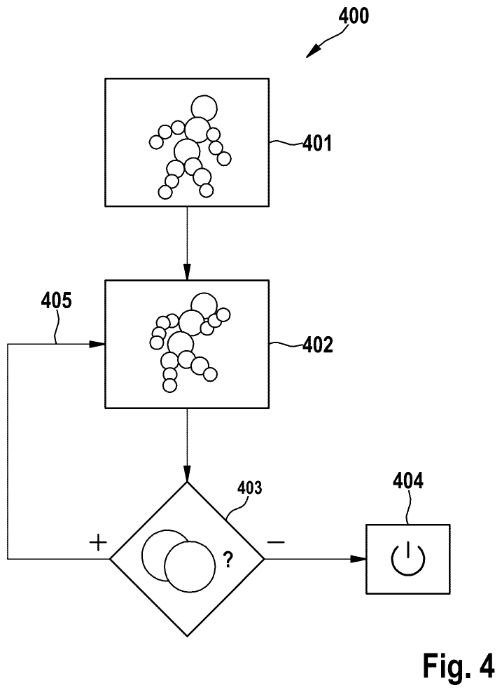

FIG. 4 shows a flow chart illustrating the generation of a pose by means of a posable ball model.

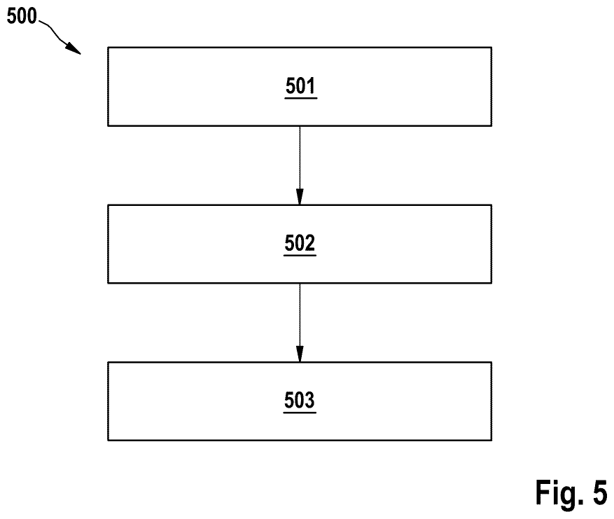

FIG. 5 shows a flow diagram depicting a method for generating a ball model of an object for generating realistic poses.

The following detailed description relates to the accompanying drawings, which, for clarification, show specific details and aspects of this disclosure in which the invention may be implemented. Other aspects may be used, and structural, logical and electrical changes may be performed without departing from the scope of protection of the invention. The various aspects of this disclosure are not necessarily mutually exclusive since some aspects of this disclosure may be combined with one or a plurality of other aspects of this disclosure to form new aspects.

Different examples will be described in more detail in the following.

FIG. 1 shows a vehicle 101.

In the example of FIG. 1, a vehicle 101, for example a vehicle like a car or truck, is equipped with a vehicle control device 102 (e.g., an electronic control unit (ECU)).

The vehicle control device 102 has data processing components, e.g., a processor (e.g., a CPU (central processing unit)) 103 and a memory 104 for storing control software 107 according to which the vehicle control device 102 operates, and data processed by the processor 103. The processor 103 executes the control software 107 (it is therefore shown in FIG. 1 as part of the processor 103).

For example, the stored control software (computer program) comprises instructions that, when executed by the processor, cause the processor 103 to execute driver assistance functions or even to control the vehicle autonomously.

The control software 107 is, for instance, transmitted to the vehicle 101 from a computer system 105, for example via a network 106 (or also using a storage medium such as a memory card). This can also be done during operation (or at least when the vehicle 101 is with the user), because over time the control software 107 is updated to new versions, for example.

The control software 107 can, for example, be trained by means of machine learning (ML), i.e., the control software 107 implements one or more ML models 108 (or machine learning model), which is trained on the basis of training data, by computer system 105 in this example. The computer system 105 thus implements an ML training algorithm for training the one or more ML models 108, which serve for object detection, for example (e.g., of other traffic participants).

Training an ML model, such as a neural network, requires a large amount of training data. For example, as in the example above, if an ML model is to be trained that performs object detection, i.e., an object detector that is to recognize people in images, thousands of images are needed for the training that represent people in various poses. In addition, these images must be marked (“annotated”) showing where exactly the people can be seen in the images. The taking and annotating of images is time-consuming and costly, especially since this is three-dimensional data with human body poses. In the case of images that include people, data protection aspects also come into play.

One way to reduce these difficulties is by using synthetically generated (image) data. The advantages here include that a large amount of this data can be produced at low cost and additionally the annotations of the data can be co-created automatically and in a highly accurate manner. In this case, data protection aspects are also omitted.

However, in the synthetically generated data, people must be represented in realistic poses so that ML models trained on the synthetic data work smoothly for real data (real images), i.e., the ML model is trained to generalize to real cases.

The 3D geometry of virtual people is essentially built from two components: The “skin” and underlying skeleton. The “skin” is usually represented by a polygonal wire mesh consisting of triangles. This wire mesh is stretched onto a virtual skeleton that can be utilized to move the virtual person into different poses. The latter is also referred to as “posing”. Note that not all poses represent realistic people. For example, it is conceivable that the virtual person's arms will be positioned within the chest, which would not happen in reality. Thus, there may be self-overlapping of the wire mesh.

There are approaches for minimizing or avoiding these self-overlaps. The naive approach is to check, for each triangle of the wire mesh, whether it collides with any other triangle. However, common wire mesh networks of virtual people consist of thousands to tens of thousands of triangles, which means a great deal of time and memory with respect to collision testing. Another option is to approximate the wire mesh with a number of cylinders, reducing the number of collision tests required. However, only a rough approximation of the geometry of the virtual person is possible, which is often not accurate enough.

According to various embodiments, an approach is used in which a wire mesh (especially a virtual person but possibly an animal or a robot) is approximated with a number of geometrical primitives (e.g., balls). From such a ball model, a posable ball model is then generated (i.e., such that it may be used in different (realistic) poses). This is then brought into different poses, wherein cases of self-overlapping of the balls are taken into account.

In other words, according to various embodiments, the human 3D geometry is approximated by a number of posable balls (i.e., a posable ball model following a skeletal structure according to various embodiments), allowing for efficient collision calculations to efficiently check for self-overlapping. The posability of the balls allows the calculated collisions to be avoided by changing the position of the balls to achieve poses that no longer have overlaps.

The goal is thus to first position a set of balls in three-dimensional space such that the surface of the balls represents the surface of a virtual person. For this purpose, it is assumed that SDF values of points in the space (i.e., SDF values of points in the space with respect to the respective wire mesh) are available for different wire meshes of virtual people. The set of these points is hereinafter referred to as a predetermined set of points in space. For example, they may be randomly selected and then the SDF values of these points can be calculated relative to the wire mesh (e.g., by calculating the distance to each triangle of the wire mesh and establishing the minimum across those distances).

The signed distance function (SDF) is one way to mathematically represent 3D geometry. It can be constructed using a wire mesh of the 3D geometry (in the present example, the shape of a person). For any point in space (for which an SDF value is to be determined), the smallest distance of the point to the surface of the wire mesh is calculated. By means of the sign of the distance, it is possible to represent whether the point is inside (negative sign) or outside (positive sign) of the wire mesh. Points on the surface of the wire mesh have an SDF value of zero. Thus, the surface of an object of 3D geometry can be represented by a set of points with associated SDF values. In general, SDFs are also suitable for calculating collisions of two objects. For a point on the surface of one object, the SDF value for the second object can be calculated. If this SDF value is positive, no collision occurs. If the value is negative, the objects will collide. However, for self-overlapping, this method is not applicable: The SDF value is always the smallest distance to the surface. Thus, if a part of the wire mesh is overlapping itself and a point is selected on the surface, then the SDF value is always zero, since the point is already on the surface of the wire mesh. Thus, testing for self-overlapping is a more difficult problem than general collision testing and other methods of collision calculation are necessary.

According to various embodiments, a ball model of the 3D geometry is generated. Then, the self-overlapping test may be performed based on whether (any) two balls of the ball model overlap one another. To test whether two balls overlap, first the distance between the midpoints of the balls is calculated. The radii of the two balls are now subtracted from this distance. If this value is less than zero, the balls are colliding; if greater than zero, no collision is occurring.

A ball model may be generated using SDF values for a given wire mesh as follows: First, it should be noted that an SDF value can be determined for a set of balls for any point in space. For this purpose, the smallest distances to the surfaces of all balls are determined for the point in space. The smallest of these distances is used as the SDF value for the point (relating to the set of balls). To generate a ball model for a given wire mesh, the midpoints and the radii of the balls are adjusted to minimize the error between the SDF values of the points relative to the set of balls and the SDF values of the points relative to the wire mesh. In this way, the surface of the wire mesh is approximated by the surfaces of the balls.

To achieve generalizability of the method for different wire meshes, a neural network can be used. The task of this network is to predict the parameters of the balls. The input variable of the neural network is sampled from a hidden state space (i.e., a latent space) according to a probability distribution, the parameters of which are learned during training (e.g., a Gaussian normal distribution). As a result, similar ball models have similar values in the hidden state space. This property can then be exploited to transition any wire mesh into a ball model.

FIG. 2 shows a flow chart 200 illustrating the training of a neural network to convert a wire mesh into a ball model.

In 201, a state vector is first sampled from a hidden state space. This occurs according to a probability distribution with certain parameters, e.g., a Gaussian normal distribution with the mean and the variance as parameters (which are initially set to start values but are adjusted during the training).

The sampled state vector is fed in 202 to the neural network (to be trained) (e.g., which was initially initialized with random weights) as an input, which network determines the parameters of the ball model (midpoints of the balls and their radii) on this basis.

For this purpose, in 203, three loss components (i.e., components of a loss function) are determined
1) errors between the SDF values of the points of the predetermined set of points in space relative to the set of balls and the SDF values of the points of the predetermined set of points in space relative to the wire mesh.
2) deviations in the probability distribution sampled from the latent space and a predetermined probability distribution (e.g., difference between the mean of the Gaussian distribution of 0 and difference between the variance of the Gaussian distribution of 1).
3) errors that evaluate whether all balls of the determined ball model contain a point within the wire mesh (or at least exactly on the wire mesh), i.e., at least partially overlap the wire mesh model. This is, for example, a sum of individual errors across all balls of the ball model, wherein the individual error of a ball is zero, for example, if the ball contains a point within (or on) the wire mesh, and, for example, the farther the point of the ball closest to the wire mesh is from the wire mesh, the larger the error becomes.

If the value of the loss function (with these three components, e.g., calculated over a batch of training wire mesh models) is small enough (i.e., below a predetermined threshold), the training is ended in 204.

If the error is not small enough, in 205, the parameters of the neural network and the parameters of the probability distribution are adjusted towards decreasing the loss function (via backpropagation) and the training is iteratively continued (typically for a new batch).

Thus, based on the loss function, both the neural network and the probability distribution parameters that are sampled from the latent space are adjusted. For example, the expected value and variance of a Gaussian normal distribution are adjusted such that a state vector that would provide a low value for the loss function becomes more likely than the sampled one (e.g., viewed on average across a batch).

With respect to the third component of the loss function as described above, it should be noted that for any point with an associated SDF value, there are any number of placements of a ball to achieve the same SDF value for the point. In particular, balls may be placed inside or outside the wire mesh to be approximated by the ball model. For a realistic approximation of the wire mesh, it is desired that all balls lie within the wire mesh. Therefore, the third component of the loss function during the training requires that each ball contains at least one point, which was originally within the wire mesh.

After training the neural network, it may be used to transform any wire mesh of a virtual person into a ball model.

FIG. 3 shows a flowchart 300 illustrating the generation of a ball model for a wire mesh model.

In 301, points are determined on the surface of the wire mesh (their SDF values relative to the wire mesh are zero).

At 302, a state vector is sampled from the latent space according to the probability distribution learned.

In 303, the trained neural network is used to obtain a ball model, i.e., a set of balls with their position in space and their radii, from the Gaussian state vector. These balls may not reflect the desired wire mesh well enough yet.

Thus, in 304, SDF values of the points determined on the surface of the wire mesh are calculated relative to the ball model and summed to an error. By means of an optimization method for minimizing this error, a state vector is now sought, which, when used as an input to the neural network, leads to such error being as small as possible. Thus, the state vector is iteratively changed, supplied to the neural network, and the error for the resulting ball model is calculated until the error is sufficiently small.

Alternatively, a second upstream neural network (encoder) may also provide the state vector that directly predicts certain points on the wire mesh. This encoder must then be additionally trained either together (jointly) with the downstream neural network (which can determine the ball model from the state vector and be seen as a decoder) or subsequently with training data.

If a desired wire mesh has now been converted into a ball model, images with a human in a realistic pose are generated using the ball model as explained above. To do this, the balls must be posed according to an underlying skeletal structure. For this purpose, the skeleton of the underlying wire mesh (i.e., the virtual skeleton of the wire mesh) can be used directly.

To do this, the balls of the ball model are associated with the joints of the skeleton so that the balls can move according to the joints. The underlying wire mesh is also used for this purpose. Each point of the wire mesh has corresponding skeleton weights, which are used to associate the point with the joints of the skeleton. For each ball, the distance from the surface of the ball to the points of the wire mesh is now determined. Thus, a set of wire mesh points may be determined that are nearest to the ball (e.g., eight). By interpolating the skeleton weights for these nearest points, a skeleton weight can be determined for each ball. This results in a posable ball model, which can now be used to create a realistic pose (in which self-overlaps are avoided).

FIG. 4 shows a flow chart 400 illustrating the generation of a pose by means of a posable ball model.

Starting from any initial pose 401, a pose 402 is first generated by changing the position of the balls in consideration of the skeletal structure (i.e., the weights of the balls in relation to the skeleton).

For this purpose, the midpoints of the balls are moved (taking into account their weights), and the points of a wire mesh would be moved (taking into account their weights), such as in a method like linear blend skinning. For example, positions of joints may be changed randomly and the resulting ball midpoints determined or the positions of the midpoints of individual balls may be changed and the midpoints of the other balls adjusted according to the skeletal structure (whereby boundary conditions (e.g., maximum distances) are met when changing the positions of the individual balls): for example, if two adjacent balls were placed very far apart, it could be difficult or impossible to find a good pose, which depicts this).

Then, in 403, a collision calculation of the balls with each other is performed, i.e., for the pose, each ball of the ball model is tested against all remaining balls for collisions, as described above. If no collisions are found, the pose is valid and can be considered realistic and is further processed in 404 (e.g., used to render a training image).

If collisions are found, the joints of the skeleton that are responsible for the collision may be determined in 405 by using the skeleton weights of the balls. The position of the respective joints can now be varied such that the colliding balls are separated (i.e., “pushed away”) from each other. For example, the pose for two colliding balls is altered (by changing the position of a joint upon which the distance of the two balls depends) until the balls no longer overlap.

This creates a new pose. Starting from this (i.e., instead of any initial pose), the procedure can be repeated, that is iterated until no more balls collide (whereby upon reaching a “dead end” or if a certain number of iterations that did not lead to success are overwritten, it can be started again from an initial pose). The resulting pose may then be considered valid. The pose may also be automatically iteratively optimized in an auto-gradient framework.

If a valid (realistic) pose has been found by means of the ball model in this way, it can be used to generate an image. To this end, the realistic pose is applied to the underlying wire mesh to generate an image with the wire mesh.

In summary, according to various embodiments, a method as shown in FIG. 5 is provided.

FIG. 5 shows a flow chart 500 depicting a method for generating a ball model of an object (typically a human form but potentially also an animal) for generation of realistic poses (i.e., a (realistic) posable ball model).

In 501, a wire mesh model of the object is received, wherein the wire mesh model has a skeletal structure (i.e., each point of the wire mesh model, i.e., each vertex, typically a triangular vertex in the case of a wire mesh model composed of triangles, has one or more weights that associate it with one or more joints of a skeleton).

In 502, a first ball model is generated from the wire mesh model (containing a plurality of balls each having a position of the respective midpoint in three-dimensional space and a radius).

In 503, a second (realistically posable) ball model is generated from the first ball model by determining, for each ball of the first ball model, a set of nearest points of the wire mesh model (i.e., vertices), and, for each of one or more joints of the skeletal structure, calculating a weight for the balls by averaging the weights of the points nearest to the joint, and assigning the calculated weight to the ball.

The method of FIG. 5 may be performed by one or a plurality of computers comprising one or a plurality of data processing units. The term “data processing unit” may be understood to mean any type of entity that enables the processing of data or signals. The data or signals may, for example, be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail here may also be understood as a data processing unit or logic circuit array. One or a plurality of the method steps described in detail here may be carried out (e.g., implemented) by a data processing unit by means of one or a plurality of specific functions performed by the data processing unit.

According to various embodiments, the method is thus, in particular, computer-implemented.

1. A method for generating a ball model of an object for generating realistic poses, comprising:
receiving a wire mesh model of the object, the wire mesh model including has a skeletal structure having one or more joints;
generating a first ball model from the wire mesh model; and
generating a second ball model from the first ball model by:
determining, for each ball of the first ball model, a number of nearest points of the wire mesh model, and
calculating, for each corresponding joint of the one or more joints of the skeletal structure, a weight for balls of the second ball model by averaging weights of points of the wire mesh model nearest to the corresponding joint, and
assigning the weight to corresponding balls of the second ball model.

2. The method according to claim 1, further comprising:
calculating the weight for each corresponding joint of the skeletal structure and assigning to the corresponding balls a predetermined number of the weights that are largest among the weights.

3. The method according to claim 1, further comprising:
generating the first ball model from the wire mesh model using a neural network that receives a randomly selected state vector from a state space as input,
wherein the randomly selected state vector is adjusted such that the first ball model approximates the wire mesh model.

4. The method according to claim 3, further comprising:
training the neural network to reduce a loss comprising at least a portion several loss components including:
a first loss component penalizing a deviation of a ball model generated for a training wire mesh model by the neural network from the training wire mesh model;
a second loss component penalizing for each non-overlapping ball of a ball model generated for the training wire mesh model by the neural network, when the non-overlapping ball does not overlap with the training wire mesh model; and
a third loss component penalizing a deviation of a probability distribution sampled from the state space from a predetermined probability distribution.

5. A method for generating a pose of an object comprising:
generating a ball model of an object according to the method of claim 1, the ball model including a plurality of balls, and
generating the pose by modifying midpoint positions of at least a portion of the balls of the plurality of balls, based on the weights assigned to the balls of the plurality of balls.

6. The method according to claim 5, further comprising:
checking the pose for self-collisions by checking, for pairs of balls of the plurality of balls, whether the balls in the generated pose overlap and, when one or more self-collisions are identified, modifying the pose to avoid at least a portion of the one or more self-collisions.

7. The method according to claim 6, wherein the modifying comprises moving apart overlapping balls of the plurality of balls by moving one or more joints associated with the overlapping balls according to the weights assigned to the balls.

8. A method for generating training images for a machine learning model, comprising:
generating a pose of an object according to the method of claim 5 and rendering the object in the pose in front of a background.

9. A method for training a machine learning model for detecting objects, comprising:
generating training images for a machine learning model according to the method of claim 8; and
training the machine learning model using the training images.

10. A method for controlling a robotic device, comprising:
training a machine learning model according to the method of claim 9,
detecting one or more objects in an area surrounding the robotic device; and
controlling the robotic device based on the one or more objects.

11. The method of claim 1, wherein a data processing system is configured to carry out the method.

12. The method of claim 1, wherein a computer program includes instructions that, when executed by a processor, cause the processor to carry out the method.

13. The method of claim 1, wherein a non-transitory computer-readable medium stores instructions that, when executed by a processor, cause the processor to carry out the method.
